(19) United States
(12) Patent Application Publication
(10) Pub. No.: US 2019/0313005 A1
(43) Pub. Date: Oct. 10, 2019

(54) TONE MAPPING FOR HIGH-DYNAMIC-RANGE IMAGES

(71) Applicant: QUALCOMM Incorporated, San Diego, CA (US)

(72) Inventors: Jiangtao Kuang, La Jolla, CA (US); Changjung Kao, San Diego, CA (US); Xiaoyun Jiang, San Diego, CA (US)

(21) Appl. No.: 15/946,568

(22) Filed: Apr. 5, 2018

(51) Int. Cl. H04N 5/235; G06T 7/80; H04N 9/73; G06T 7/90; H04N 5/232; G06T 5/00; G06T 5/40; G06T 5/50

(52) U.S. Cl. CPC H04N 5/2355; G06T 7/80; H04N 9/73; G06T 7/90; G06T 2207/20208; G06T 5/009; G06T 5/40; G06T 5/50; H04N 5/23229

(57) ABSTRACT

A device may identify a first pixel array representing a high dynamic range (HDR) image of a scene. The device may determine one or more image statistics associated with the HDR image based on the first pixel array. The device may generate a corrected pixel array by applying an interpolative operation to the first pixel array, where the image statistics may be determined based on the corrected pixel array. The device may generate one or more tone-mapping curves for the HDR image based on the image statistics. The device may generate a compressed image of the scene by applying the one or more tone-mapping curves to the first pixel array. The device may output the compressed image of the scene (e.g., to a display of the device, to a system memory, etc.).

### BACKGROUND

The following relates generally to image processing, and more specifically to tone mapping for high-dynamic-range (HDR) images.

Spectral responses of human eyes and spectral responses of digital sensors (e.g., cameras) and/or displays may be different. Thus, colors obtained by a digital sensor may differ from colors perceived by humans. For example, the human eye may constantly adjust to a broad range of luminance present in an environment, allowing the brain to interpret information in a wide range of light conditions. Similarly, devices may use image processing techniques to convert image data (e.g., Bayer data) to various color formats and may perform various enhancements and modifications to the raw image.

In some cases, these enhancements may include combining multiple exposures of a scene (e.g., where each exposure may be associated with a respective brightness or luminance) into an HDR image. The HDR image may utilize more bits per pixel value and therefore may be capable of displaying a wider range of luminance, but the additional bits may in some cases require higher transmission bandwidth, higher computation power, more complex processors, etc. Additionally, in some cases (e.g., because of differing light conditions and other factors in the scene), some image processing techniques may generate less accurate representations of the scene (e.g., color artifacts). Improved techniques for tone mapping of an image may be desired.

### SUMMARY

The described methods, systems, devices, or apparatuses relate to improved support for tone mapping of high-dynamic-range (HDR) images. Generally, the described techniques provide for performing tone-mapping earlier in the process (e.g., the image processing pipeline), which may in some cases save bandwidth and decrease a computational cost of processing.

A method of image processing at a device is described. The method may include identifying a first pixel array representing an HDR image of a scene, determining one or more image statistics associated with the HDR image based at least in part on the first pixel array, generating one or more tone-mapping curves for the HDR image based at least in part on the one or more image statistics, generating a compressed image of the scene by applying the one or more tone-mapping curves to the first pixel array, and outputting the compressed image of the scene.

Another apparatus for image processing at a device is described. The apparatus may include a processor, memory in electronic communication with the processor, and instructions stored in the memory. The instructions may be operable to cause the processor to identify a first pixel array representing an HDR image of a scene, determine one or more image statistics associated with the HDR image based at least in part on the first pixel array, generate one or more tone-mapping curves for the HDR image based at least in part on the one or more image statistics, generate a compressed image of the scene by applying the one or more tone-mapping curves to the first pixel array, and output the compressed image of the scene.

Some examples of the method and apparatus described above may further include processes, features, means, or instructions for generating a corrected pixel array by applying an interpolative operation to the first pixel array, wherein the one or more image statistics associated with the HDR image may be determined based at least in part on the corrected pixel array.

In some examples of the method and apparatus described above, determining the one or more image statistics associated with the HDR image comprises computing an overall image mean value for the corrected pixel array, an overall image histogram for the corrected pixel array, one or more local image mean values for the corrected pixel array, or one or more local image histograms for the corrected pixel array, or a combination thereof.

In some examples of the method and apparatus described above, outputting the compressed image of the scene comprises passing the compressed image of the scene from an image sensor of the device to an image signal processor (ISP) of the device, wherein the one or more tone-mapping curves for the HDR image may be generated by the image sensor of the device.

Some examples of the method and apparatus described above may further include processes, features, means, or instructions for passing feedback information from the ISP of the device to the image sensor of the device, the feedback information comprising one or more of an exposure time, an exposure gain, a lens shading profile, a white balance gain, or a color correction matrix, wherein the one or more image statistics associated with the HDR image may be determined based at least in part on the feedback information.

In some examples of the method and apparatus described above, the interpolative operation comprises one or more of a black level subtraction, a lens shading correction, a white balance correction, or a color correction.

Some examples of the method and apparatus described above may further include processes, features, means, or instructions for capturing, at an image sensor of the device, a plurality of exposures of the scene, each exposure of the plurality of exposures being associated with a respective brightness, wherein the first pixel array may be based at least in part on the plurality of exposures.

In some examples of the method and apparatus described above, identifying the first pixel array comprises generating, at the image sensor of the device, the first pixel array based at least in part on the plurality of exposures of the scene. Some examples of the method and apparatus described above may further include processes, features, means, or instructions for passing the first pixel array from the image sensor of the device to an ISP of the device, wherein the one or more tone-mapping curves for the HDR image may be generated by the ISP of the device.

In some examples of the method and apparatus described above, identifying the first pixel array comprises passing each exposure of the plurality of exposures from the image sensor of the device to an ISP of the device. Some examples of the method and apparatus described above may further include processes, features, means, or instructions for applying, by the ISP, a respective interpolative operation to each exposure of the plurality of exposures to generate a set of filtered exposures. Some examples of the method and apparatus described above may further include processes, features, means, or instructions for generating, by the ISP, the first pixel array based at least in part on the set of filtered exposures.

In some examples of the method and apparatus described above, outputting the compressed image of the scene comprises passing the compressed image of the scene from an image sensor of the device to an ISP of the device, wherein the one or more tone-mapping curves for the HDR image may be generated by the image sensor of the device.

Some examples of the method and apparatus described above may further include processes, features, means, or instructions for generating, by the ISP, a color-corrected image of the scene by applying a second interpolative operation to the compressed image of the scene. Some examples of the method and apparatus described above may further include processes, features, means, or instructions for writing the color-corrected image of the scene to a memory component of the device.

Some examples of the method and apparatus described above may further include processes, features, means, or instructions for outputting the compressed image comprises transmitting the compressed image of the scene to a second device.

In some examples of the method and apparatus described above, each tone-mapping curve comprises a respective nonlinear mapping for a set of pixel values that comprises the first pixel array to a second set of pixel values that comprises the compressed image of the scene.

### BRIEF DESCRIPTION OF THE DRAWINGS

FIG. 1 illustrates an example of an image processing diagram that supports tone mapping for HDR images in accordance with aspects of the present disclosure.

FIGS. 2 through 6 illustrate example process flows that support tone mapping for HDR images in accordance with aspects of the present disclosure.

FIG. 7 shows a block diagram of a device that supports tone mapping for HDR images in accordance with aspects of the present disclosure.

FIG. 8 illustrates a block diagram of a system including a device that supports tone mapping for HDR images in accordance with aspects of the present disclosure.

FIGS. 9 through 13 illustrate methods for tone mapping for HDR images in accordance with aspects of the present disclosure.

### DETAILED DESCRIPTION

Accurate reproduction of the true color(s) in a scene may be based on processing of pixel values for one or more image arrays representing the scene. For example, a device may contain a sensor which may be operable to capture one or more exposures of a scene. In some cases, the device may additionally or alternatively contain an image signal processor (ISP) which may be operable to adjust the image arrays generated by the sensor. That is, in some cases the sensor and ISP may be components (e.g., of separate devices), such that the image arrays generated by the sensor are communicated to the ISP via a wired or wireless communication link. Alternatively, the sensor and the ISP may be components of the same device (e.g., wireless device), such that the image arrays generated by the sensor are communicated to the ISP using communications internal to the device (e.g., a system bus).

The processing and/or communication of the image arrays may in some cases depend on the amount of data within the image arrays. For example, image arrays which use a larger number of bits to represent each pixel (e.g., HDR images), may in some cases be associated with higher transmission bandwidths and/or computation costs. Thus, while such some image arrays may produce higher quality images (e.g., images with better contrast, better color representation, etc.), this quality may in some cases be offset by transmission or computation constraints. Aspects of the present disclosure relate to improved techniques for processing images.

Aspects of the disclosure are initially described in the context of an array of images and related operations. Aspects of the disclosure are then illustrated by and described with reference to process flow diagrams. Aspects of the disclosure are further illustrated by and described with reference to apparatus diagrams, system diagrams, and flowcharts that relate to tone mapping for images (e.g., HDR images).

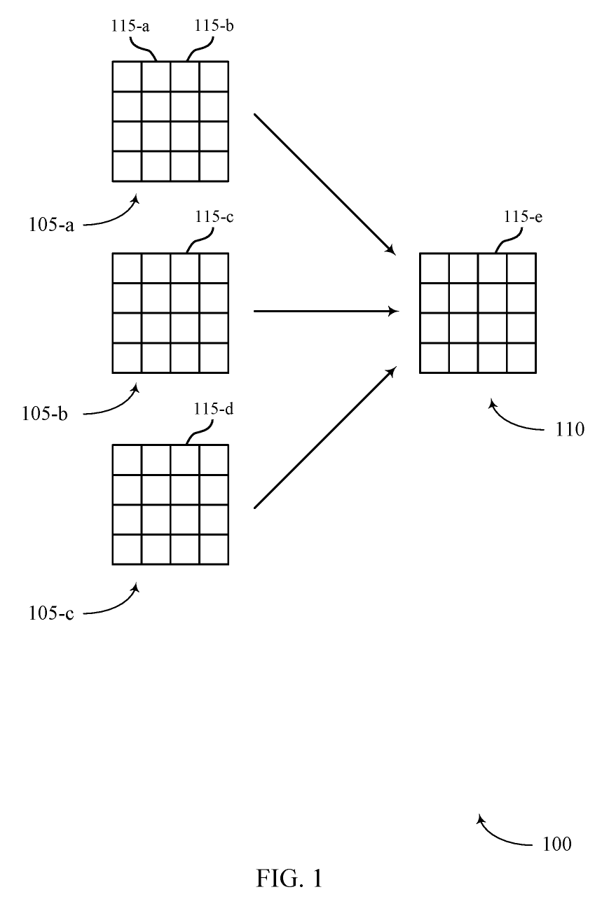

FIG. 1 illustrates an example of an image processing diagram 100 that supports tone mapping for HDR images in accordance with aspects of the present disclosure. For example, image processing diagram 100 may be performed by a device, such as a mobile device. A mobile device may also be referred to as a user equipment (UE), a wireless device, a remote device, a handheld device, or a subscriber device, or some other suitable terminology, where the “device” may also be referred to as a unit, a station, a terminal, or a client. A mobile device may be a personal electronic device such as a cellular phone, a personal digital assistant (PDA), a tablet computer, a laptop computer, or a personal computer. In some examples, a mobile device may also refer to a wireless local loop (WLL) station, an Internet of Things (IoT) device, an Internet of Everything (IoE) device, a machine type communication (MTC) device, or the like, which may be implemented in various articles such as appliances, vehicles, meters, or some other suitable terminology.

The device performing the techniques illustrated with respect to image processing diagram 100 may in some cases contain a sensor (e.g., for capturing exposures 105) and/or an ISP (e.g., for processing exposures 105 to generate an image array 110). For example, the sensor may generate exposures 105 based on capturing representations of a scene under different exposure conditions (e.g., different brightness). Thus, exposure 105-a may be associated with a relatively low brightness, exposure 105-b may be associated with an intermediate brightness, and exposure 105-c may be associated with a relatively high brightness. Though described in the context of differing brightness, it is to be understood that other conditions may additionally or alternatively distinguish exposures 105 (e.g., different image filters, different lens positions, etc.).

Exposure 105-a may be represented as a pixel array containing a plurality of pixel values 115, where each pixel value is represented by a number of bits N. In some cases, the pixel values 115 may be generated based on light passing through a color filter array (e.g., a Bayer filter). Thus, pixel value 115-a may represent color(s) of a first wavelength while a neighboring pixel value 115 (e.g., pixel value 115-b) may represent color(s) of a second wavelength.

The sensor and/or ISP may be operable to process the exposures 105 to generate image array 110. For example, the sensor and/or ISP may process pixel value 115-b, pixel value 115-c, and pixel value 115-d to generate pixel value 115-e in image array 110. In some cases, pixel value 115-e may be represented by a number of bits I, where I>N. For example, a three-exposure 105 combined HDR image (e.g., image array 110) may use twenty bits per pixel because of the extended data range (compared to ten bits per pixel for a standard dynamic range (SDR) image). Image array 110 may in some cases undergo additional processing (e.g., tone-mapping) in accordance with aspects of the present disclosure. Additionally or alternatively, such tone mapping may be applied to each exposure 105 (e.g., as part of generating image array 110). Tone mapping may generally refer to techniques which map one set of colors to another to approximate the appearance of HDR images in a medium that has a more limited dynamic range. Thus, tone mapping may be used for image compression (e.g., for storage and/or representation by a display).

Generally, the larger number of bits per pixel may require a higher transmission bandwidth, a higher computational power, more complex hardware (e.g., system on chip (SoC) processors), etc. Tone mapping may be used to reduce the number of bits (e.g., saving bandwidth and/or computational costs). Aspects of the present disclosure relate to techniques for applying the tone mapping earlier in the image processing pipeline (e.g., in the front end of an ISP or inside the image sensor before the output). For example, the described techniques may include combining exposures 105 in the Bayer domain before all ISP modules (e.g., and using tone mapping to compress the bit width). These ISP modules may include black level subtraction, lens shading correction, white balance, color correction, and other such processing modules.

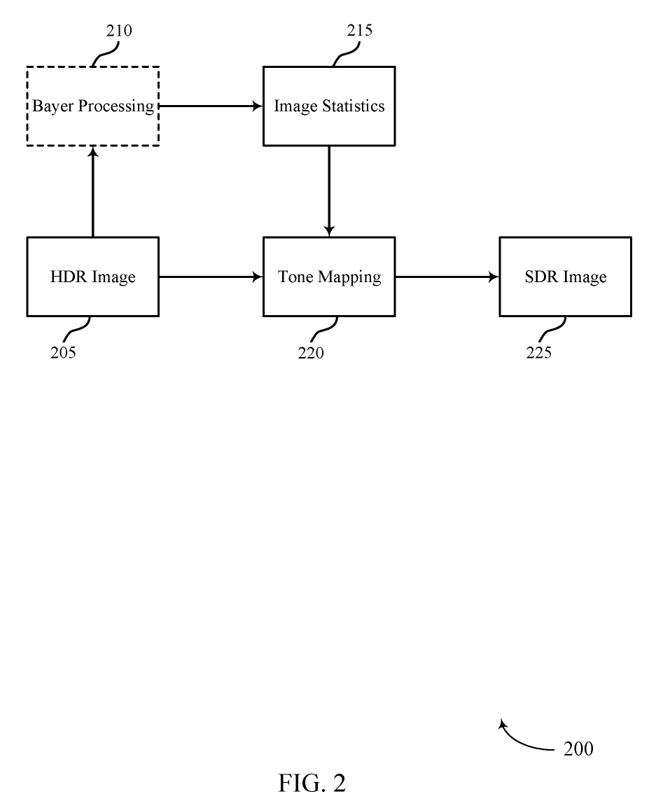

In accordance with the described techniques, tone mapping may be used to process Bayer image date (e.g., to compress the data bit-width without sacrificing all dynamic range information of the image). For example, tone mapping may be performed inside a complementary metal-oxide-semiconductor (CMOS) HDR image sensor before outputting the image data or in the front part of an ISP of a SoC (e.g., to save bandwidth and computation cost). Such techniques may compress the bit width of the image, which may remove the need to process each individual exposure 105 using the entire ISP before performing the tone mapping. Considerations for such tone mapping are discussed further below with respect to FIGS. 2 through 6.

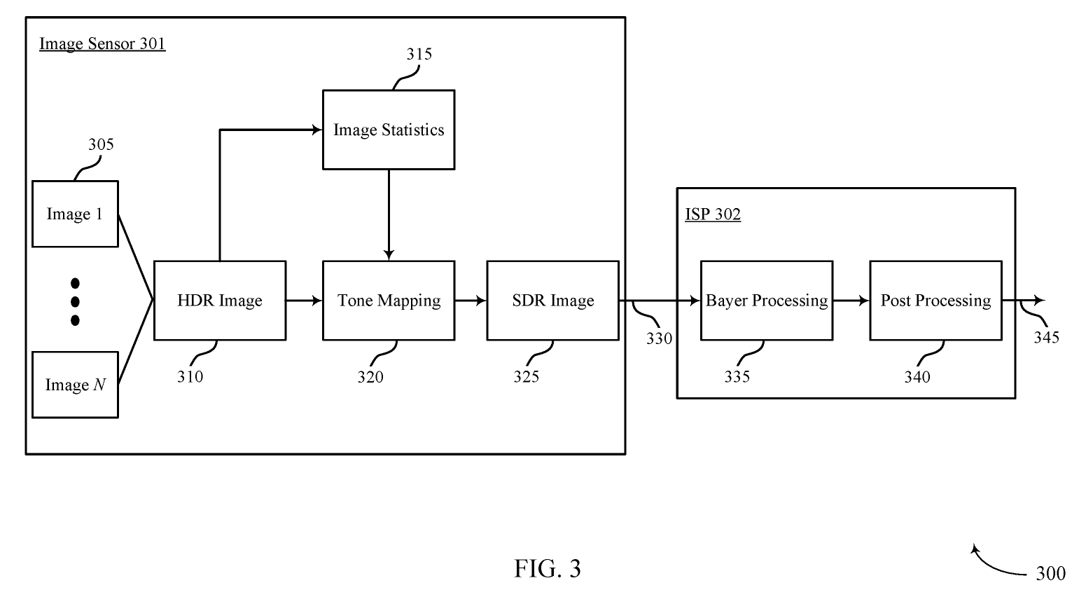

FIG. 2 illustrates an example of a process flow 200 that supports tone mapping for HDR images in accordance with aspects of the present disclosure. For example, process flow 200 may be implemented by a mobile device as described with reference to FIG. 1. In some cases, portions of process flow 200 may be performed by different devices (e.g., as described with reference to FIGS. 3 through 6).

At 205, a device may identify a first pixel array representing an HDR image of a scene. For example, the device may generate the first pixel array (e.g., as described with reference to image processing diagram 100. Alternatively, the device may receive the HDR image from another device (e.g., over a wireless communication link).

At 210, the device may, in some, but not all cases, generate a corrected pixel array by applying an interpolative operation to the first pixel array. For example, the interpolative operation may refer to or include a set of Bayer processing operations. In some cases, the interpolative operation may alternatively be referred to as a demosaicing operation or algorithm, which may be a digital image process used to reconstruct a full color image from the incomplete color samples output from an image sensor overlaid with a color filter array. Example interpolative operations include, but are not limited to, multivariate interpolation on a uniform grid, nearest-neighbor interpolation, bilinear interpolation, bicubic interpolation, spline interpolation, and Lanczos resampling.

In some cases, the interpolative operation applied at 210 may be a simplified version of an interpolative operation performed later in the image processing pipeline. That is, an algorithm with a reduced complexity may be applied at 210 to approximate the effects of the Bayer processing before computation of image statistics at 215. In some cases, the interpolative operation may additionally or alternatively include considerations for one or more of a black level subtraction, a lens shading correction, a white balance correction, a color correction, and/or a combination of these, each of which may be applied later in the image processing pipeline in some cases. For example, lens shading correction may apply a lens shading profile to an image, where the lens shading profile may make the corners and/or edges of the image brighter (e.g., to compensate for the lens fall-off shading). Similarly, white balance may make the image brighter by applying red, green, and blue gains to balance the illuminant color. Black level subtraction may refer to removing the black level (e.g., a constant offset of the image data). Color correction may be achieved through the use of one or more color correction matrices.

In some cases, the interpolative operation applied at 210 may be based on feedback information from another component of the device (e.g., from a later portion of the image processing pipeline) or from another component of another device. For example, the feedback information may indicate an exposure time and gains, a lens shading profile, a white balance gain, a color correction matrix, etc. to tune the interpolative operation.

At 215, the device may determine one or more image statistics associated with the HDR image based at least in part on the first pixel array representing the HDR image. In some cases, the image statistics may be based on the corrected pixel array (e.g., may be based on the interpolative operation applied at 210). Example image statistics may include, but are not limited to, an overall image mean value (e.g., an overall luminance or some other representative value), where the overall image mean value may provide an index (e.g., to a look-up table) indicating a tone-mapping curve. Additional or alternative examples of image statistics may also include one or more of an overall image histogram (e.g., which may provide a measure of the spread of brightness or other similar values across the entire image), one or more local image mean values (e.g., which may provide similar information to the overall image mean value but for a region of the entire image), or one or more local image histogram statistics (e.g., which may provide similar information to the overall image histogram but for a region of the entire image).

At 220, the image statistics may be used to generate one or more tone mapping curves for the HDR image. For example, the tone mapping curve(s) may be applied to the Luma value of the pixels. That is, the HDR image at 205 may represent the scene in the Bayer domain (e.g., where there is only one color component value for each pixel). In the Bayer domain, the Luma value may be generated using a filter having a first size (e.g., a 3×3 filter, a filter of another size) to average the Bayer pixel values for a given region.

At 225, the device may generate a compressed image of the scene (e.g., an SDR image) by applying the one or more tone mapping curves. The device may then output the compressed image of the scene (e.g., to a memory of the device, to a display of the device, to a communication link with another device, etc.).

FIG. 3 illustrates an example of a process flow 300 that supports tone mapping for HDR images in accordance with aspects of the present disclosure. For example, process flow 300 may be implemented by a mobile device as described with reference to FIG. 1. As one example, process flow 300 may be performed by or relate to image sensor 301, ISP 302, or other components, or a combination thereof. In the example illustrated with respect to process flow 300, tone mapping may be performed within image sensor 301, which may lower the computational burden on ISP 302 and/or the bandwidth required to transfer data between image sensor 301 and ISP 302.

At 305, image sensor 301 may capture multiple exposures of a scene, where each exposure is associated with a respective brightness.

At 310, image sensor 301 may generate a first pixel array representing an HDR image of the scene based on the multiple exposures (e.g., as described with reference to FIG. 1). In some cases, the first pixel array may comprise a Bayer domain representation of the scene.

At 315, image sensor 301 may determine one or more image statistics associated with the HDR image. In some cases, the image statistics may be based on Bayer processing information (e.g., as described with reference to FIG. 2).

At 320, image sensor 301 may generate one or more tone-mapping curves for the HDR image based on the image statistics (e.g., as described with reference to FIG. 2).

At 325, image sensor 301 may apply the one or more tone-mapping curves to the HDR image (e.g., in the Bayer domain) to generate an SDR image of the scene.

At 330, image sensor 301 may output the SDR image of the scene to ISP 302 of the device. Performing the tone mapping in the image sensor in this way may reduce the computational power required by ISP 302 and/or reduce the bandwidth required to output the SDR image to ISP 302.

At 335, ISP 302 may apply a Bayer processing operation to the SDR image. For example, the Bayer processing operation applied at 335 may include a more computationally robust version of the approximate Bayer processing operation applied to generate the image statistics. Example Bayer processing operations may include, but are not limited to, a black level subtraction, a lens shading correction, a white balance correction, a color correction, and/or a combination of these.

At 340, ISP 302 may apply one or more processing operations to the Bayer processed SDR image. For example, the processing operations may refer to image cropping, size alteration, image orientation adjustment, blending, etc.

At 345, ISP 302 may output the processed image (e.g., to a display of the device, to a memory component of the device, to a communication link with another device, etc.).

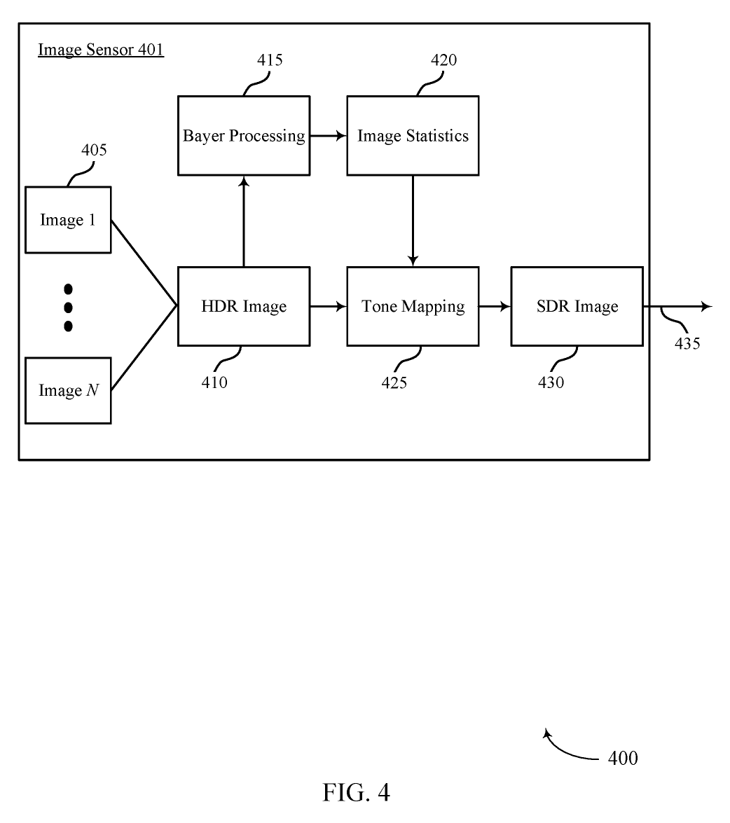

FIG. 4 illustrates an example of a process flow 400 that supports tone mapping for HDR images in accordance with aspects of the present disclosure. For example, process flow 400 may be implemented by a mobile device as described with reference to FIG. 1. As one example, process flow 400 may be performed by or relate to image sensor 401. In the example illustrated with respect to process flow 400, tone mapping may be performed within image sensor 401, which may lower the computational burden on an ISP and/or the bandwidth required to transfer data between image sensor 401 and the ISP. Additionally, the Bayer processing considerations in determining the image statistics discussed below may improve the quality of the processed image (e.g., by removing color artifacts), among other advantages.

At 405, image sensor 401 may capture multiple exposures of a scene, where each exposure is associated with a respective brightness.

At 410, image sensor 401 may generate a first pixel array representing an HDR image of the scene based on the multiple exposures (e.g., as described with reference to FIG. 1). In some cases, the first pixel array may comprise a Bayer domain representation of the scene.

At 415, image sensor 401 may apply an interpolative operation (e.g., Bayer processing) to the first pixel array. For example, the interpolative operation may approximate or otherwise generate a representation of the effects of various modules that are further downstream in the image processing pipeline.

At 420, image sensor 401 may determine one or more image statistics associated with the HDR image based on the Bayer processing information generated at 415 (e.g., as described with reference to FIG. 2).

At 425, image sensor 401 may generate one or more tone-mapping curves for the HDR image based on the image statistics (e.g., as described with reference to FIG. 2). Considering the Bayer processing in determining the image statistics may reduce color artifacts associated with generation of an SDR image or otherwise improve the quality of the SDR image. For example, each tone mapping curve may include a respective nonlinear mapping for pixel values of the first pixel array to pixel values of a compressed image of the scene. In some cases, a tone mapping curve may be applied to each pixel of the first pixel array. Additionally or alternatively, a tone mapping curve may be applied to a given region of the first pixel array.

At 430, image sensor 401 may apply the one or more tone-mapping curves to the HDR image (e.g., in the Bayer domain) to generate an SDR image of the scene.

At 435, image sensor 401 may output the SDR image of the scene to an ISP of the device, to a memory component of the device, to a display of the device, to a communication link with another device, etc.

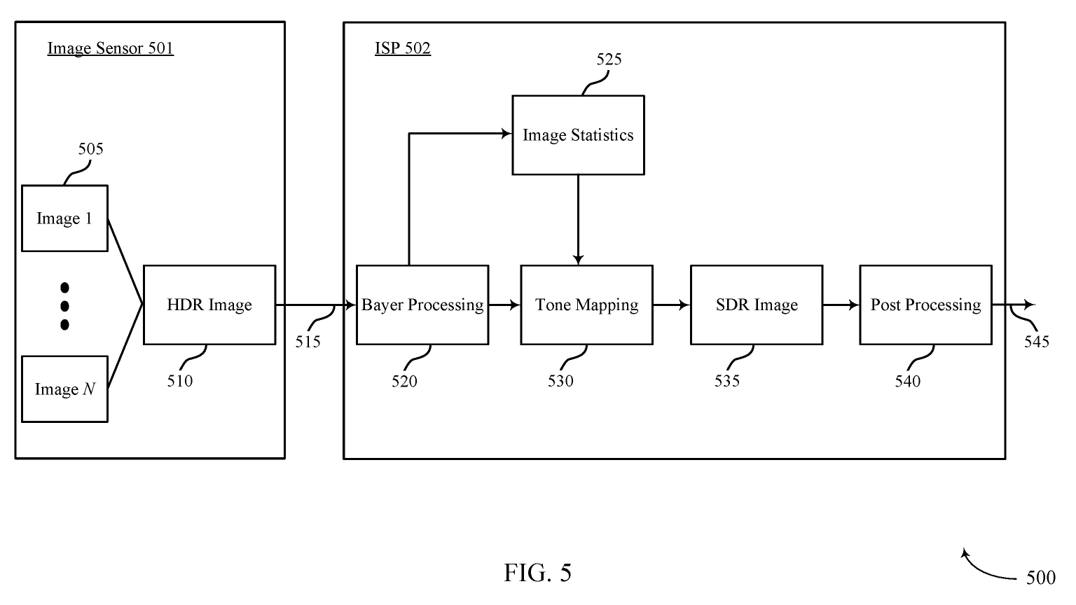

FIG. 5 illustrates an example of a process flow 500 that supports tone mapping for HDR images in accordance with aspects of the present disclosure. For example, process flow 500 may be implemented by a mobile device as described with reference to FIG. 1. As one example, process flow 500 may be performed by or relate to image sensor 501, ISP 502, or other components, or a combination thereof. In the example illustrated with respect to process flow 500, tone mapping may be performed within ISP 502, which may lower the computational burden on image sensor 501 (e.g., at the cost of an increased bandwidth required to transfer data between image sensor 501 and ISP 502). Additionally, the Bayer processing considerations in determining the image statistics discussed below may improve the quality of the processed image (e.g., by removing color artifacts), among other advantages.

At 505, image sensor 501 may capture multiple exposures of a scene, where each exposure is associated with a respective brightness.

At 510, image sensor 501 may generate a first pixel array representing an HDR image of the scene based on the multiple exposures (e.g., as described with reference to FIG. 1). In some cases, the first pixel array may comprise a Bayer domain representation of the scene.

At 515, image sensor 501 may output the first pixel array to ISP 502 (e.g., or an ISP of another device via a communication link).

At 520, ISP 502 (e.g., or the ISP of the other device) may apply an interpolative operation to the first pixel array. For example, the interpolative operation may approximate or otherwise generate a representation of the effects of various modules that are further downstream in the image processing pipeline.

At 525, ISP 502 may determine one or more image statistics associated with the HDR image based on the Bayer processing information generated at 520 (e.g., as described with reference to FIG. 2).

At 530, ISP 502 may generate one or more tone-mapping curves for the HDR image based on the image statistics (e.g., as described with reference to FIG. 2). Considering the Bayer processing in determining the image statistics may reduce color artifacts associated with generation of an SDR image or otherwise improve the quality of the SDR image.

At 535, ISP 502 may apply the one or more tone-mapping curves to the HDR image (e.g., in the Bayer domain) to generate an SDR image of the scene.

At 540, ISP 502 may apply one or more processing operations to the Bayer processed SDR image. For example, the processing operations may refer to image cropping, size alteration, image orientation adjustment, blending, etc.

At 545, ISP 502 may output the SDR image of the scene to an ISP of the device, to a memory component of the device, to a display of the device, to a communication link with another device, etc.

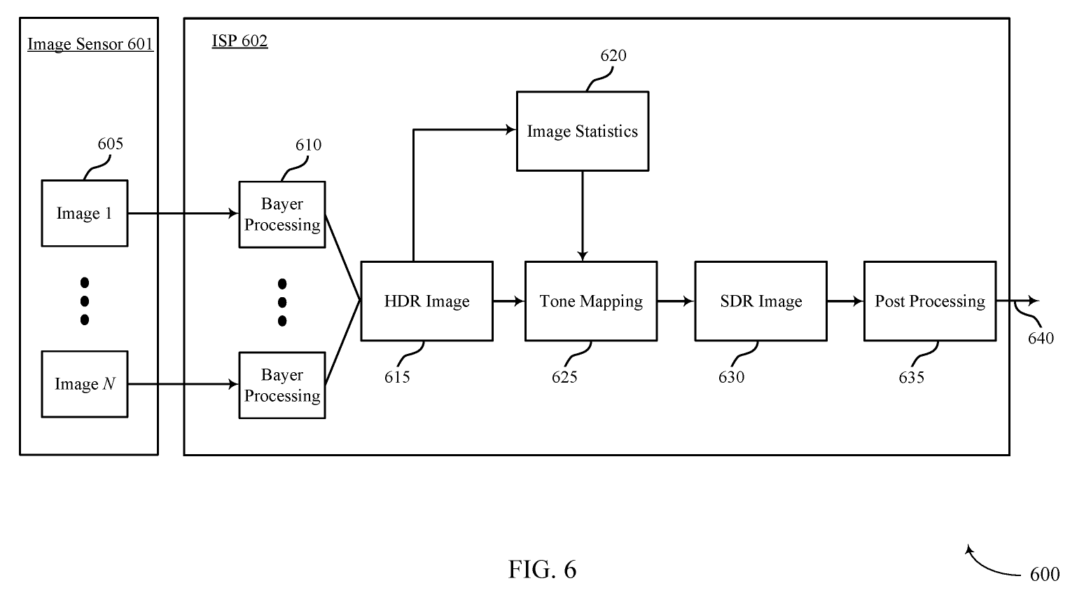

FIG. 6 illustrates an example of a process flow 600 that supports tone mapping for HDR images in accordance with aspects of the present disclosure. For example, process flow 600 may be implemented by a mobile device as described with reference to FIG. 1. As one example, process flow 600 may be performed by or relate to image sensor 601, ISP 602, or other components, or a combination thereof. In the example illustrated with respect to process flow 600, tone mapping may be performed within ISP 602, which may lower the computational burden on image sensor 601 (e.g., at the cost of an increased bandwidth required to transfer data between image sensor 601 and ISP 602). Additionally, the Bayer processing considerations in determining the image statistics discussed below may improve the quality of the processed image (e.g., by removing color artifacts), among other examples.

At 605, image sensor 601 may capture multiple exposures of a scene, where each exposure is associated with a respective brightness.

At 610, ISP 602 may apply a respective interpolative operation to each of the multiple exposures. For example, each respective interpolative operation may approximate or otherwise generate a representation of the effects of various modules that are further downstream in the image processing pipeline. In some cases, each respective interpolative operation may refer to a same interpolative operation (e.g., such that each exposure is processed using a same interpolative operation). Alternatively, each respective interpolative operation may differ (e.g., based on a respective brightness associated with the exposure to which the respective interpolative operation is applied).

At 615, ISP 602 may generate a first pixel array representing an HDR image of the scene based on the multiple exposures (e.g., as described with reference to FIG. 1). In some cases, the first pixel array may comprise a Bayer domain representation of the scene.

At 620, ISP 602 may determine one or more image statistics associated with the HDR image based on the Bayer processing information generated at 610 (e.g., as described with reference to FIG. 2).

At 625, ISP 602 may generate one or more tone-mapping curves for the HDR image based on the image statistics (e.g., as described with reference to FIG. 2). Considering the Bayer processing in determining the image statistics may reduce color artifacts associated with generation of an SDR image or otherwise improve the quality of the SDR image.

At 630, ISP 602 may apply the one or more tone-mapping curves to the HDR image (e.g., in the Bayer domain) to generate an SDR image of the scene.

At 635, ISP 602 may apply one or more processing operations to the Bayer processed SDR image.

At 640, ISP 602 may output the SDR image of the scene to a memory component of the device, to a display of the device, to a communication link with another device, etc.

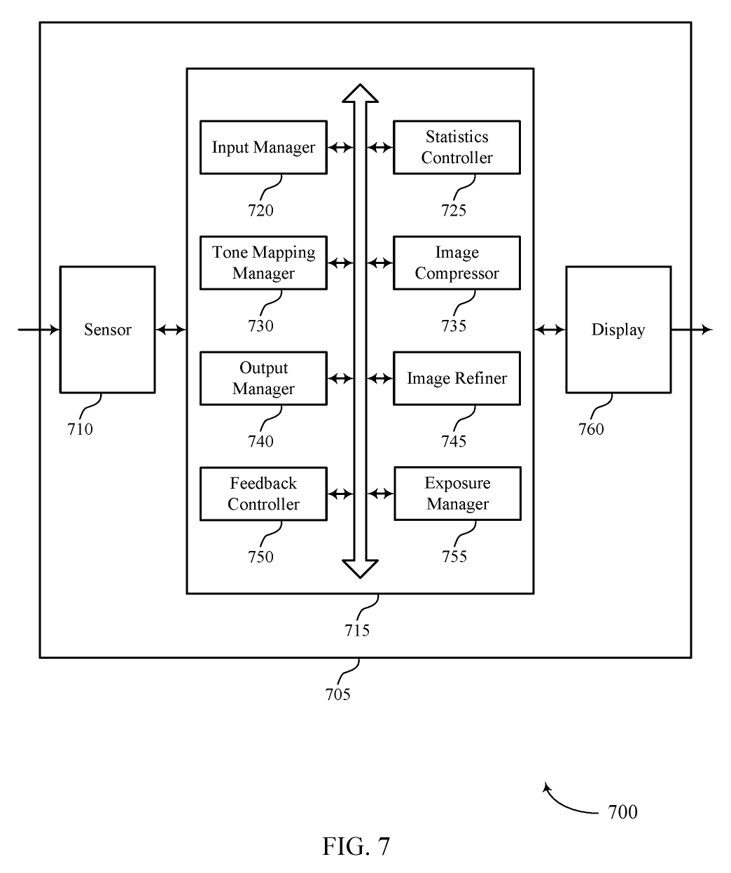

FIG. 7 shows a block diagram 700 of a device 705 that supports tone mapping for HDR images in accordance with aspects of the present disclosure. Device 705 may include sensor 710, image processing controller 715, and display 760. Device 705 may also include a processor. Each of these components may be in communication with one another (e.g., via one or more buses).

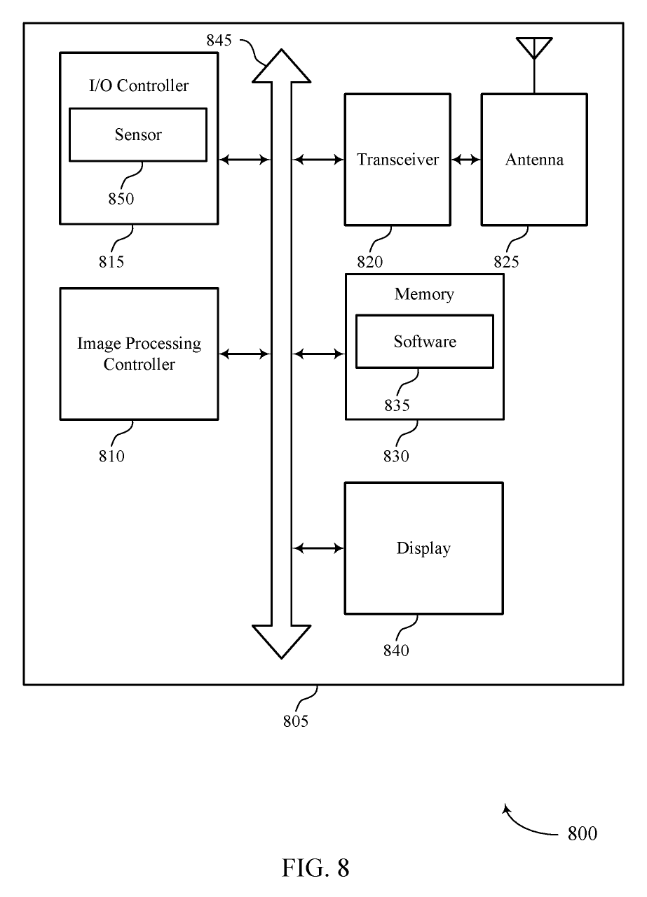

Sensor 710 may include or be an example of a digital imaging sensor for taking photos and video. In some examples, sensor 710 may receive information such as packets, user data, or control information associated with various information channels (e.g., from a transceiver 820 described with reference to FIG. 8). Information may be passed on to other components of the device. Additionally or alternatively, components of device 705 used to communicate data over a wireless (e.g., or wired) link may be in communication with image processing controller 715 (e.g., via one or more buses) without passing information through sensor 710.

Image processing controller 715 may be an example of aspects of the image processing controller 810 described with reference to FIG. 8. Image processing controller 715 and/or at least some of its various sub-components may be implemented in hardware, software executed by a processor, firmware, or any combination thereof. If implemented in software executed by a processor, the functions of the image processing controller 715 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The image processing controller 715 and/or at least some of its various sub-components may be physically located at various positions, including being distributed such that portions of functions are implemented at different physical locations by one or more physical devices. In some examples, image processing controller 715 and/or at least some of its various sub-components may be a separate and distinct component in accordance with various aspects of the present disclosure. In other examples, image processing controller 715 and/or at least some of its various sub-components may be combined with one or more other hardware components, including but not limited to an input/output (I/O) component, a transceiver, a network server, another computing device, one or more other components described in the present disclosure, or a combination thereof in accordance with various aspects of the present disclosure.

Image processing controller 715 may include input manager 720, statistics controller 725, tone mapping manager 730, image compressor 735, output manager 740, image refiner 745, feedback controller 750, and exposure manager 755. Each of these modules may communicate, directly or indirectly, with one another (e.g., via one or more buses).

Input manager 720 may identify a first pixel array representing an HDR image of a scene, pass the first pixel array from the image sensor of the device to an ISP of the device, where the one or more tone-mapping curves for the HDR image are generated by the ISP of the device. Input manager 720 may pass each exposure of the set of exposures from the image sensor of the device to an ISP of the device. Input manager 720 may apply a respective interpolative operation to each exposure of the set of exposures to generate a set of filtered exposures. Input manager 720 may generate the first pixel array based on the set of filtered exposures.

Statistics controller 725 may determine one or more image statistics associated with the HDR image based on the first pixel array. Statistics controller 725 may compute an overall image mean value for the corrected pixel array, an overall image histogram for the corrected pixel array, one or more local image mean values for the corrected pixel array, or one or more local image histograms for the corrected pixel array, or a combination thereof.

Tone mapping manager 730 may generate one or more tone-mapping curves for the HDR image based on the one or more image statistics. In some cases, each tone-mapping curve includes a respective nonlinear mapping for a set of pixel values that includes the first pixel array to a second set of pixel values that includes the compressed image of the scene.

Image compressor 735 may generate a compressed image of the scene by applying the one or more tone-mapping curves to the first pixel array.

Output manager 740 may output the compressed image of the scene, pass the compressed image of the scene from an image sensor of the device to an ISP of the device, where the one or more tone-mapping curves for the HDR image are generated by the image sensor of the device, generate, by the ISP, a color-corrected image of the scene by applying a second interpolative operation to the compressed image of the scene, write the color-corrected image of the scene to a memory component of the device, and output the compressed image includes transmitting the compressed image of the scene to a second device.

Image refiner 745 may generate a corrected pixel array by applying an interpolative operation to the first pixel array, where the one or more image statistics associated with the HDR image are determined based on the corrected pixel array. In some cases, the interpolative operation includes one or more of a black level subtraction, a lens shading correction, a white balance correction, or a color correction.

Feedback controller 750 may pass feedback information from the ISP of the device to the image sensor of the device, the feedback information including one or more of an exposure time, an exposure gain, a lens shading profile, a white balance gain, or a color correction matrix, where the one or more image statistics associated with the HDR image are determined based on the feedback information.

Exposure manager 755 may capture, at an image sensor of the device, a set of exposures of the scene, each exposure of the set of exposures being associated with a respective brightness, where the first pixel array is based on the set of exposures and generate, at the image sensor of the device, the first pixel array based on the set of exposures of the scene.

Display 760 may be a touchscreen, a light emitting diode (LED), a monitor, etc. In some cases, display 760 may be replaced by system memory. That is, in some cases in addition to (or instead of) being displayed by device 705, the processed image may be stored in a memory of device 705.

FIG. 8 shows a diagram of a system 800 including a device 805 that supports tone mapping for HDR images in accordance with aspects of the present disclosure. Device 805 may be an example of or include the components of device 705. Device 805 may include components for bi-directional voice and data communications including components for transmitting and receiving communications. Device 805 may include image processing controller 810, I/O controller 815, transceiver 820, antenna 825, memory 830, and display 840. These components may be in electronic communication via one or more buses (e.g., bus 845).

Image processing controller 810 may include an intelligent hardware device, (e.g., a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a programmable logic device, a discrete gate or transistor logic component, a discrete hardware component, or any combination thereof). In some cases, image processing controller 810 may be configured to operate a memory array using a memory controller. In other cases, a memory controller may be integrated into image processing controller 810. Image processing controller 810 may be configured to execute computer-readable instructions stored in a memory to perform various functions (e.g., functions or tasks supporting face tone color enhancement).

I/O controller 815 may manage input and output signals for device 805. I/O controller 815 may also manage peripherals not integrated into device 805. In some cases, I/O controller 815 may represent a physical connection or port to an external peripheral. In some cases, I/O controller 815 may utilize an operating system such as iOS®, ANDROID®, MS-DOS®, MS-WINDOWS®, OS/2®, UNIX®, LINUX®, or another known operating system. In other cases, I/O controller 815 may represent or interact with a modem, a keyboard, a mouse, a touchscreen, or a similar device. In some cases, I/O controller 815 may be implemented as part of a processor. In some cases, a user may interact with device 805 via I/O controller 815 or via hardware components controlled by I/O controller 815. In some cases, I/O controller 815 may be or include sensor 850. Sensor 850 may be an example of a digital imaging sensor for taking photos and video. For example, sensor 850 may represent a camera operable to obtain a raw image of a scene, which raw image may be processed by image processing controller 810 according to aspects of the present disclosure.

Transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas. In some cases, the wireless device may include a single antenna 825. However, in some cases the device may have more than one antenna 825, which may be capable of concurrently transmitting or receiving multiple wireless transmissions.

Device 805 may participate in a wireless communications system (e.g., may be an example of a mobile device). A mobile device may also be referred to as a UE, a wireless device, a remote device, a handheld device, or a subscriber device, or some other suitable terminology, where the “device” may also be referred to as a unit, a station, a terminal, or a client. A mobile device may be a personal electronic device such as a cellular phone, a PDA, a tablet computer, a laptop computer, or a personal computer. In some examples, a mobile device may also refer to a WLL station, an IoT device, an IoE device, a MTC device, or the like, which may be implemented in various articles such as appliances, vehicles, meters, or the like.

Memory 830 may comprise one or more computer-readable storage media. Examples of memory 830 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. Memory 830 may store program modules and/or instructions that are accessible for execution by image processing controller 810. That is, memory 830 may store computer-readable, computer-executable software 835 including instructions that, when executed, cause the processor to perform various functions described herein. In some cases, the memory 830 may contain, among other things, a basic input/output system (BIOS) which may control basic hardware or software operation such as the interaction with peripheral components or devices. The software 835 may include code to implement aspects of the present disclosure, including code to support tone mapping for HDR images. Software 835 may be stored in a non-transitory computer-readable medium such as system memory or other memory. In some cases, the software 835 may not be directly executable by the processor but may cause a computer (e.g., when compiled and executed) to perform functions described herein.

Display 840 represents a unit capable of displaying video, images, text or any other type of data for consumption by a viewer. Display 840 may include a liquid-crystal display (LCD), a LED display, an organic LED (OLED), an active-matrix OLED (AMOLED), or the like. In some cases, display 840 and I/O controller 815 may be or represent aspects of a same component (e.g., a touchscreen) of device 805.

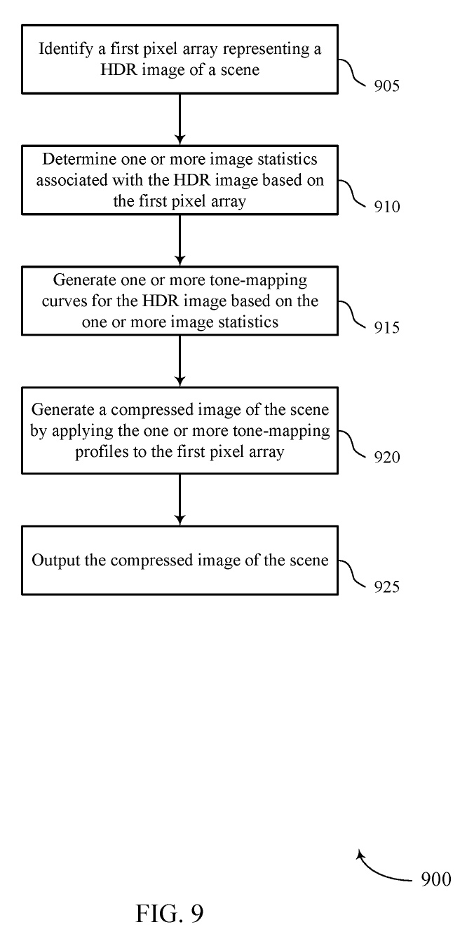

FIG. 9 shows a flowchart illustrating a method 900 for tone mapping for HDR images in accordance with aspects of the present disclosure. The operations of method 900 may be implemented by a device or its components as described herein. For example, the operations of method 900 may be performed by an image processing controller as described with reference to FIGS. 7 and 8. In some examples, a device may execute a set of codes to control the functional elements of the device to perform the functions described below. Additionally or alternatively, the device may perform aspects of the functions described below using special-purpose hardware.

At 905 the device may identify a first pixel array representing an HDR image of a scene. The operations of 905 may be performed according to the methods described herein. In certain examples, aspects of the operations of 905 may be performed by an input manager as described with reference to FIG. 7.

At 910 the device may determine one or more image statistics associated with the HDR image based at least in part on the first pixel array. The operations of 910 may be performed according to the methods described herein. In certain examples, aspects of the operations of 910 may be performed by a statistics controller as described with reference to FIG. 7.

At 915 the device may generate one or more tone-mapping curves for the HDR image based at least in part on the one or more image statistics. The operations of 915 may be performed according to the methods described herein. In certain examples, aspects of the operations of 915 may be performed by a tone mapping manager as described with reference to FIG. 7.

At 920 the device may generate a compressed image of the scene by applying the one or more tone-mapping curves to the first pixel array. The operations of 920 may be performed according to the methods described herein. In certain examples, aspects of the operations of 920 may be performed by an image compressor as described with reference to FIG. 7.

At 925 the device may output the compressed image of the scene. The operations of 925 may be performed according to the methods described herein. In certain examples, aspects of the operations of 925 may be performed by an output manager as described with reference to FIG. 7.

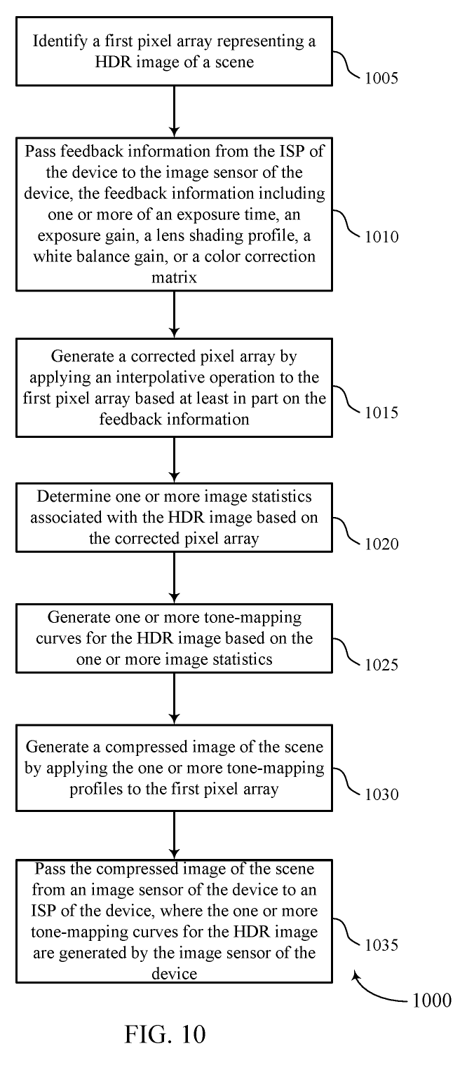

FIG. 10 shows a flowchart illustrating a method 1000 for tone mapping for HDR images in accordance with aspects of the present disclosure. The operations of method 1000 may be implemented by a device or its components as described herein. For example, the operations of method 1000 may be performed by an image processing controller as described with reference to FIGS. 7 and 8. In some examples, a device may execute a set of codes to control the functional elements of the device to perform the functions described below. Additionally or alternatively, the device may perform aspects of the functions described below using special-purpose hardware.

At 1005 the device may identify a first pixel array representing an HDR image of a scene. The operations of 1005 may be performed according to the methods described herein. In certain examples, aspects of the operations of 1005 may be performed by an input manager as described with reference to FIG. 7.

At 1010 the device may pass feedback information from an ISP of the device to an image sensor of the device, the feedback information comprising one or more of an exposure time, an exposure gain, a lens shading profile, a white balance gain, or a color correction matrix. The operations of 1010 may be performed according to the methods described herein. In certain examples, aspects of the operations of 1010 may be performed by a feedback controller as described with reference to FIG. 7.

At 1015 the device may generate a corrected pixel array by applying an interpolative operation to the first pixel array, wherein the interpolative operations is based at least in part on the feedback information. The operations of 1015 may be performed according to the methods described herein. In certain examples, aspects of the operations of 1015 may be performed by an image refiner as described with reference to FIG. 7.

At 1020 the device may determine one or more image statistics associated with the HDR image based at least in part on the corrected pixel array. The operations of 1020 may be performed according to the methods described herein. In certain examples, aspects of the operations of 1020 may be performed by a statistics controller as described with reference to FIG. 7.

At 1025 the device may generate one or more tone-mapping curves for the HDR image based at least in part on the one or more image statistics. The operations of 1025 may be performed according to the methods described herein. In certain examples, aspects of the operations of 1025 may be performed by a tone mapping manager as described with reference to FIG. 7.

At 1030 the device may generate a compressed image of the scene by applying the one or more tone-mapping curves to the first pixel array. The operations of 1030 may be performed according to the methods described herein. In certain examples, aspects of the operations of 1030 may be performed by an image compressor as described with reference to FIG. 7.

At 1035 the device may pass the compressed image of the scene from an image sensor of the device to an image signal processor (ISP) of the device, wherein the one or more tone-mapping curves for the HDR image are generated by the image sensor of the device. The operations of 1035 may be performed according to the methods described herein. In certain examples, aspects of the operations of 1035 may be performed by an output manager as described with reference to FIG. 7.

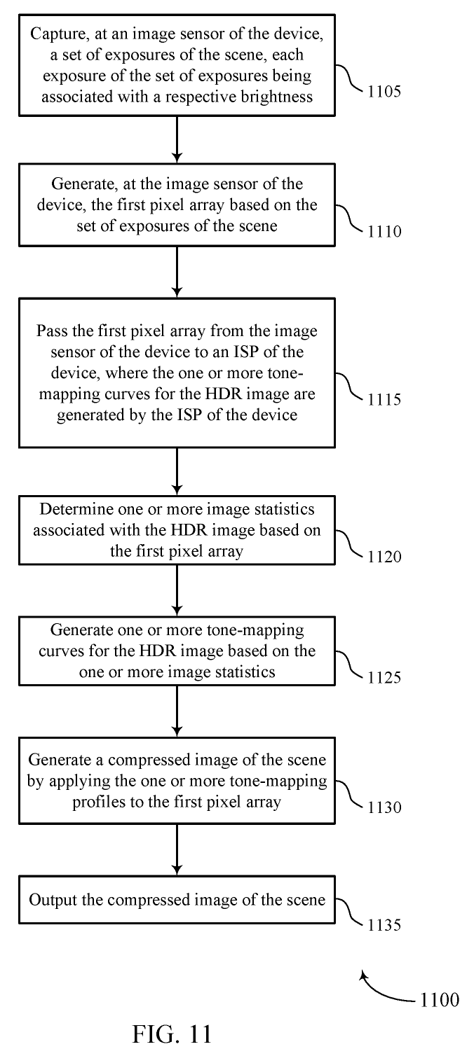

FIG. 11 shows a flowchart illustrating a method 1100 for tone mapping for HDR images in accordance with aspects of the present disclosure. The operations of method 1100 may be implemented by a device or its components as described herein. For example, the operations of method 1100 may be performed by an image processing controller as described with reference to FIGS. 7 and 8. In some examples, a device may execute a set of codes to control the functional elements of the device to perform the functions described below. Additionally or alternatively, the device may perform aspects of the functions described below using special-purpose hardware.

At 1105 the device may capture, at an image sensor of the device, a plurality of exposures of the scene, each exposure of the plurality of exposures being associated with a respective brightness, wherein the first pixel array is based at least in part on the plurality of exposures. The operations of 1105 may be performed according to the methods described herein. In certain examples, aspects of the operations of 1105 may be performed by an exposure manager as described with reference to FIG. 7.

At 1110 the device may generate, at the image sensor of the device, the first pixel array based at least in part on the plurality of exposures of the scene. The operations of 1110 may be performed according to the methods described herein. In certain examples, aspects of the operations of 1110 may be performed by an exposure manager as described with reference to FIG. 7.

At 1115 the device may pass the first pixel array from the image sensor of the device to an ISP of the device, wherein the one or more tone-mapping curves for the HDR image are generated by the ISP of the device. The operations of 1115 may be performed according to the methods described herein. In certain examples, aspects of the operations of 1115 may be performed by an input manager as described with reference to FIG. 7.

At 1120 the device may determine one or more image statistics associated with the HDR image based at least in part on the first pixel array. The operations of 1120 may be performed according to the methods described herein. In certain examples, aspects of the operations of 1120 may be performed by a statistics controller as described with reference to FIG. 7.

At 1125 the device may generate one or more tone-mapping curves for the HDR image based at least in part on the one or more image statistics. The operations of 1125 may be performed according to the methods described herein. In certain examples, aspects of the operations of 1125 may be performed by a tone mapping manager as described with reference to FIG. 7.

At 1130 the device may generate a compressed image of the scene by applying the one or more tone-mapping curves to the first pixel array. The operations of 1130 may be performed according to the methods described herein. In certain examples, aspects of the operations of 1130 may be performed by an image compressor as described with reference to FIG. 7.

At 1135 the device may output the compressed image of the scene. The operations of 1135 may be performed according to the methods described herein. In certain examples, aspects of the operations of 1135 may be performed by an output manager as described with reference to FIG. 7.

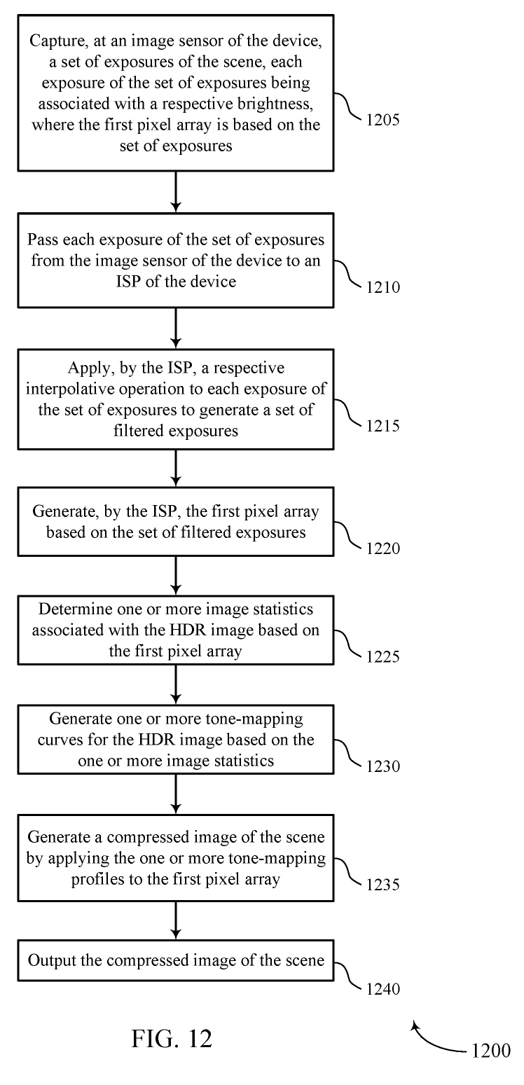

FIG. 12 shows a flowchart illustrating a method 1200 for tone mapping for HDR images in accordance with aspects of the present disclosure. The operations of method 1200 may be implemented by a device or its components as described herein. For example, the operations of method 1200 may be performed by an image processing controller as described with reference to FIGS. 7 and 8. In some examples, a device may execute a set of codes to control the functional elements of the device to perform the functions described below. Additionally or alternatively, the device may perform aspects of the functions described below using special-purpose hardware.

At 1205 the device may capture, at an image sensor of the device, a plurality of exposures of the scene, each exposure of the plurality of exposures being associated with a respective brightness, wherein the first pixel array is based at least in part on the plurality of exposures. The operations of 1205 may be performed according to the methods described herein. In certain examples, aspects of the operations of 1205 may be performed by an exposure manager as described with reference to FIG. 7.

At 1210 the device may pass each exposure of the plurality of exposures from the image sensor of the device to an ISP of the device. The operations of 1210 may be performed according to the methods described herein. In certain examples, aspects of the operations of 1210 may be performed by an input manager as described with reference to FIG. 7.

At 1215 the device may apply, by the ISP, a respective interpolative operation to each exposure of the plurality of exposures to generate a set of filtered exposures. The operations of 1215 may be performed according to the methods described herein. In certain examples, aspects of the operations of 1215 may be performed by an input manager as described with reference to FIG. 7.

At 1220 the device may generate, by the ISP, the first pixel array based at least in part on the set of filtered exposures. The operations of 1220 may be performed according to the methods described herein. In certain examples, aspects of the operations of 1220 may be performed by an input manager as described with reference to FIGS. 7 to 8.

At 1225 the device may determine one or more image statistics associated with the HDR image based at least in part on the first pixel array. The operations of 1225 may be performed according to the methods described herein. In certain examples, aspects of the operations of 1225 may be performed by a statistics controller as described with reference to FIG. 7.

At 1230 the device may generate one or more tone-mapping curves for the HDR image based at least in part on the one or more image statistics. The operations of 1230 may be performed according to the methods described herein. In certain examples, aspects of the operations of 1230 may be performed by a tone mapping manager as described with reference to FIG. 7.

At 1235 the device may generate a compressed image of the scene by applying the one or more tone-mapping curves to the first pixel array. The operations of 1235 may be performed according to the methods described herein. In certain examples, aspects of the operations of 1235 may be performed by an image compressor as described with reference to FIG. 7.

At 1240 the device may output the compressed image of the scene. The operations of 1240 may be performed according to the methods described herein. In certain examples, aspects of the operations of 1240 may be performed by an output manager as described with reference to FIG. 7.

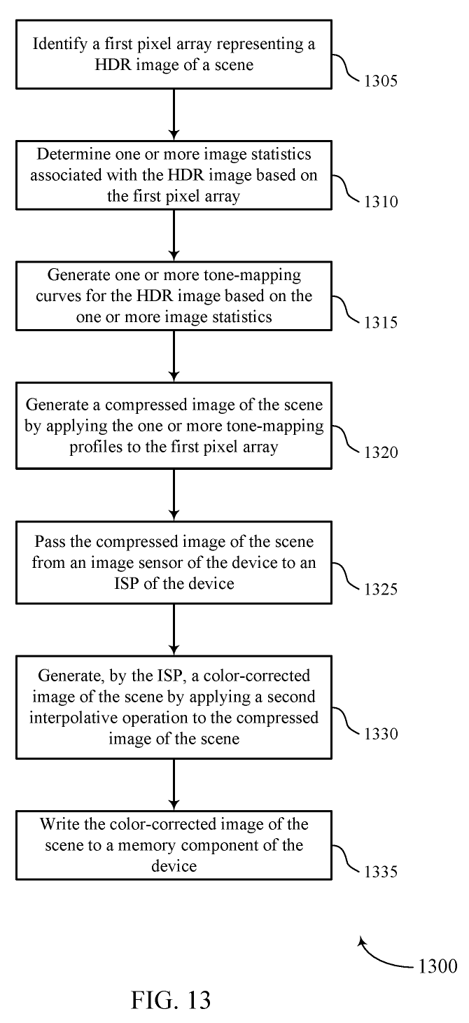

FIG. 13 shows a flowchart illustrating a method 1300 for tone mapping for HDR images in accordance with aspects of the present disclosure. The operations of method 1300 may be implemented by a device or its components as described herein. For example, the operations of method 1300 may be performed by an image processing controller as described with reference to FIGS. 7 and 8. In some examples, a device may execute a set of codes to control the functional elements of the device to perform the functions described below. Additionally or alternatively, the device may perform aspects of the functions described below using special-purpose hardware.

At 1305 the device may identify a first pixel array representing a HDR image of a scene. The operations of 1305 may be performed according to the methods described herein. In certain examples, aspects of the operations of 1305 may be performed by an input manager as described with reference to FIG. 7.

At 1310 the device may determine one or more image statistics associated with the HDR image based at least in part on the first pixel array. The operations of 1310 may be performed according to the methods described herein. In certain examples, aspects of the operations of 1310 may be performed by a statistics controller as described with reference to FIG. 7.

At 1315 the device may generate one or more tone-mapping curves for the HDR image based at least in part on the one or more image statistics. The operations of 1315 may be performed according to the methods described herein. In certain examples, aspects of the operations of 1315 may be performed by a tone mapping manager as described with reference to FIG. 7.

At 1320 the device may generate a compressed image of the scene by applying the one or more tone-mapping curves to the first pixel array. The operations of 1320 may be performed according to the methods described herein. In certain examples, aspects of the operations of 1320 may be performed by an image compressor as described with reference to FIG. 7.

At 1325 the device may pass the compressed image of the scene from an image sensor of the device to an ISP of the device, wherein the one or more tone-mapping curves for the HDR image are generated by the image sensor of the device. The operations of 1325 may be performed according to the methods described herein. In certain examples, aspects of the operations of 1325 may be performed by an output manager as described with reference to FIG. 7.

At 1330the device may generate, by the ISP, a color-corrected image of the scene by applying a second interpolative operation to the compressed image of the scene. The operations of 1330 may be performed according to the methods described herein. In certain examples, aspects of the operations of 1330 may be performed by an output manager as described with reference to FIG. 7.

At 1335 the device may write the color-corrected image of the scene to a memory component of the device. The operations of 1335 may be performed according to the methods described herein. In certain examples, aspects of the operations of 1335 may be performed by an output manager as described with reference to FIG. 7.

It should be noted that the methods described above describe possible implementations, and that the operations and the steps may be rearranged or otherwise modified and that other implementations are possible. Further, aspects from two or more of the methods may be combined. In some cases, one or more operations described above (e.g., with reference to FIGS. 9 through 13) may be omitted or adjusted without deviating from the scope of the present disclosure. Thus the methods described above are included for the sake of illustration and explanation and are not limiting of scope.

The various illustrative blocks and modules described in connection with the disclosure herein may be implemented or performed with a general-purpose processor, a DSP, an ASIC, a FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, EEPROM, flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

what is claimed is:

1. A method for image processing at a device, comprising:
identifying a first pixel array representing a high dynamic range (HDR) image of a scene;
determining one or more image statistics associated with the HDR image based at least in part on the first pixel array;
generating one or more tone-mapping curves for the HDR image based at least in part on the one or more image statistics;
generating a compressed image of the scene by applying the one or more tone-mapping curves to the first pixel array; and
outputting the compressed image of the scene.

2. The method of claim 1, further comprising:
generating a corrected pixel array by applying an interpolative operation to the first pixel array, wherein the one or more image statistics associated with the HDR image are determined based at least in part on the corrected pixel array.

3. The method of claim 2, wherein determining the one or more image statistics associated with the HDR image comprises:
computing an overall image mean value for the corrected pixel array, an overall image histogram for the corrected pixel array, one or more local image mean values for the corrected pixel array, or one or more local image histograms for the corrected pixel array, or a combination thereof.

4. The method of claim 2, wherein outputting the compressed image of the scene comprises:
passing the compressed image of the scene from an image sensor of the device to an image signal processor (ISP) of the device, wherein the one or more tone-mapping curves for the HDR image are generated by the image sensor of the device.

5. The method of claim 4, further comprising:
passing feedback information from the ISP of the device to the image sensor of the device, the feedback information comprising one or more of an exposure time, an exposure gain, a lens shading profile, a white balance gain, or a color correction matrix, wherein the one or more image statistics associated with the HDR image are determined based at least in part on the feedback information.

6. The method of claim 2, wherein the interpolative operation comprises one or more of a black level subtraction, a lens shading correction, a white balance correction, or a color correction.

7. The method of claim 1, further comprising:
capturing, at an image sensor of the device, a plurality of exposures of the scene, each exposure of the plurality of exposures being associated with a respective brightness, wherein the first pixel array is based at least in part on the plurality of exposures.

8. The method of claim 7, wherein identifying the first pixel array comprises:
generating, at the image sensor of the device, the first pixel array based at least in part on the plurality of exposures of the scene; and
passing the first pixel array from the image sensor of the device to an image signal processor (ISP) of the device, wherein the one or more tone-mapping curves for the HDR image are generated by the ISP of the device.

9. The method of claim 7, wherein identifying the first pixel array comprises:
passing each exposure of the plurality of exposures from the image sensor of the device to an image signal processor (ISP) of the device;
applying, by the ISP, a respective interpolative operation to each exposure of the plurality of exposures to generate a set of filtered exposures; and
generating, by the ISP, the first pixel array based at least in part on the set of filtered exposures.

10. The method of claim 1, wherein outputting the compressed image of the scene comprises:
passing the compressed image of the scene from an image sensor of the device to an image signal processor (ISP) of the device, wherein the one or more tone-mapping curves for the HDR image are generated by the image sensor of the device.

11. The method of claim 10, further comprising:
generating, by the ISP, a color-corrected image of the scene by applying a second interpolative operation to the compressed image of the scene; and
writing the color-corrected image of the scene to a memory component of the device.

12. The method of claim 1, wherein:
outputting the compressed image comprises transmitting the compressed image of the scene to a second device.

13. The method of claim 1, wherein each tone-mapping curve comprises a respective nonlinear mapping for a set of pixel values that comprises the first pixel array to a second set of pixel values that comprises the compressed image of the scene.

14. An apparatus for image processing, comprising:
a processor,
memory in electronic communication with the processor; and
instructions stored in the memory and operable, when executed by the processor, to cause the apparatus to:
identify a first pixel array representing a high dynamic range (HDR) image of a scene;
determine one or more image statistics associated with the HDR image based at least in part on the first pixel array;
generate one or more tone-mapping curves for the HDR image based at least in part on the one or more image statistics;
generate a compressed image of the scene by applying the one or more tone-mapping curves to the first pixel array; and
output the compressed image of the scene.

15. The apparatus of claim 14, wherein the instructions are further executable by the processor to cause the apparatus to:
generate a corrected pixel array by applying an interpolative operation to the first pixel array, wherein the one or more image statistics associated with the HDR image are determined based at least in part on the corrected pixel array.

16. The apparatus of claim 15, wherein the instructions to determine the one or more image statistics associated with the HDR image are executable by the processor to cause the apparatus to:
compute an overall image mean value for the corrected pixel array, an overall image histogram for the corrected pixel array, one or more local image mean values for the corrected pixel array, or one or more local image histograms for the corrected pixel array, or a combination thereof.

17. The apparatus of claim 15, wherein the instructions to output the compressed image of the scene are executable by the processor to cause the apparatus to:
pass the compressed image of the scene from an image sensor of the device to an image signal processor (ISP) of the device, wherein the one or more tone-mapping curves for the HDR image are generated by the image sensor of the device.

18. The apparatus of claim 14, wherein the instructions are further executable by the processor to cause the apparatus to:
capture, at an image sensor of the device, a plurality of exposures of the scene, each exposure of the plurality of exposures being associated with a respective brightness, wherein the first pixel array is based at least in part on the plurality of exposures.

19. An apparatus for image processing, comprising:
means for identifying a first pixel array representing a high dynamic range (HDR) image of a scene;
means for determining one or more image statistics associated with the HDR image based at least in part on the first pixel array;
means for generating one or more tone-mapping curves for the HDR image based at least in part on the one or more image statistics;
means for generating a compressed image of the scene by applying the one or more tone-mapping curves to the first pixel array; and
means for outputting the compressed image of the scene.

20. The apparatus of claim 19, further comprising:
means for generating a corrected pixel array by applying an interpolative operation to the first pixel array, wherein the one or more image statistics associated with the HDR image are determined based at least in part on the corrected pixel array.
